(19) United States
(12) Patent Application Publication
(10) Pub. No.: US 2019/0230203 A1
(43) Pub. Date: Jul. 25, 2019

(54) FRAME ASSEMBLY, HOUSING AND ELECTRONIC DEVICE HAVING THE SAME

(71) Applicant: GUANGDONG OPPO MOBILE TELECOMMUNICATION CORP., LTD., Dongguan (CN)

(72) Inventors: Maozhao HUANG, Dongguan (CN); Mingren Chen, Dongguan (CN)

(73) Assignee: GUANGDONG OPPO MOBILE TELECOMMUNICATION CORP., LTD., Dongguan (CN)

(21) Appl. No.: 16/202,017

(22) Filed: Nov. 27, 2018

(30) Foreign Application Priority Data
Jan. 25, 2018 (CN) 201810075034.5
Jan. 25, 2018 (CN) 201820128315.8

(51) Int. Cl. H04M 1/02

(52) U.S. Cl. CPC H04M 1/0249

(57) ABSTRACT

A frame assembly for an electronic device is provided. The frame assembly includes a first frame and a second frame. The first frame defines a receiving space for accommodating electronic elements of the electronic device. The first frame includes an exterior surface departing from the receiving space. The second frame is coupled to the exterior surface of the first frame. The first frame is made of a glass material, and the second frame and the first frame are made of different materials. A housing and an electronic device is also provided.

### CROSS-REFERENCE TO RELATED APPLICATION

This application claims priority to a Chinese application No. 201810075034.5 filed on Jan. 25, 2018, titled “MOBILE TERMINAL, HOUSING AND FRAME ASSEMBLY THEREOF”, and a Chinese application No 201820128315.8 filed on Jan. 25, 2018, titled “MOBILE TERMINAL, HOUSING AND FRAME ASSEMBLY THEREOF”. The entirety of the above-mentioned applications is hereby incorporated by reference herein.

### TECHNICAL FIELD

The present disclosure relates to the field of consumer devices in general. More particularly, and without limitation, the disclosed embodiments relate to a frame assembly, a housing and an electronic device having the same.

### BACKGROUND

Currently, an electronic device such as a mobile phone may have a rear cover, a frame assembly, and a front cover. The frame assembly may be disposed between and coupled to the rear cover and the front cover. Such that the frame assembly forms a frame of the electronic device. The frame may act as dumper casing for the electronic device, and a structure of the frame needs to be designed in a desire manner to protect the electronic device.

### SUMMARY

In accordance with an aspect, in one embodiment of the present disclosure, a frame assembly for an electronic device is provided. The frame assembly includes a first frame and a second frame. The first frame defines a receiving space for accommodating electronic elements of the electronic device. The first frame includes an exterior surface departing from the receiving space. The second frame is coupled to the exterior surface of the first frame. The first frame is made of a glass material, and the second frame is made of a material different from the glass material of the first frame.

In accordance with an aspect, in another embodiment of the present disclosure, a housing is provided. The housing includes a rear cover and a frame assembly coupled to the rear cover. The frame assembly includes a first frame and a second frame. The first frame defines a receiving space for accommodating electronic elements of the electronic device. The first frame includes an exterior surface departing from the receiving space. The second frame is coupled to the exterior surface of the first frame. The first frame is made of a glass material, and the second frame and the first frame are made of different materials.

In accordance with an aspect, in further another embodiment of the present disclosure, an electronic device is provided. The electronic device includes a rear cover, a display module, and frame assembly. The rear cover and the display module are coupled to opposite sides of the frame assembly. The frame assembly includes a first frame and a second frame. The first frame defines a receiving space for accommodating electronic elements of the electronic device. The first frame includes an exterior surface departing from the receiving space. The second frame is coupled to the exterior surface of the first frame. The first frame is a glass-made frame, and the second frame is a nonmetal frame.

### BRIEF DESCRIPTION OF THE DRAWINGS

The accompanying drawings, which are incorporated in and constitute a part of this specification, illustrate exemplary embodiments of the present disclosure, and together with the description, serve to explain the principles of the disclosure.

FIG. 1 illustrates a schematic perspective view of an electronic device, in accordance with an embodiment of the present disclosure;

FIG. 2 illustrates a schematic perspective view of a frame assembly of the electronic device of FIG. 1;

FIG. 3 illustrates an enlarged schematic view of an area III of the frame assembly of FIG. 2, in accordance with another embodiment of the present disclosure;

FIG. 4 illustrates a schematic cross-sectional view of the frame assembly of FIG. 3;

FIG. 5 illustrates an enlarged schematic view of an area III of the frame assembly of FIG. 2, in accordance with further another embodiment of the present disclosure;

FIG. 6 illustrates a schematic cross-sectional view of the frame assembly of FIG. 5;

FIG. 7 illustrates a schematic cross-sectional view of the frame assembly of FIG. 5, in accordance with till another embodiment of the present disclosure;

FIG. 8 illustrates a schematic cross-sectional view of the frame assembly of FIG. 5, in accordance with till another embodiment of the present disclosure;

FIG. 9 illustrates a schematic cross-sectional view of the frame assembly of FIG. 5, in accordance with till another embodiment of the present disclosure;

FIG. 10 illustrates a schematic view of a hardware environment of an electronic device, in accordance with an embodiment of the present disclosure.

### DETAILED DESCRIPTION OF EMBODIMENTS

This description and the accompanying drawings that illustrate exemplary embodiments should not be taken as limiting. Various mechanical, structural, electrical, and operational changes may be made without departing from the scope of this description and the claims, including equivalents. In some instances, well known structures and techniques have not been shown or described in detail so as not to obscure the disclosure. Similar reference numbers in two or more figures represent the same or similar elements.

Furthermore, elements and their associated features that are disclosed in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

As used herein, a “communication terminal”, “electronic device” or simply a “terminal”) includes, but is not limited to, a device that is configured to receive/transmit communication signals via a wire line connection, such as via a public-switched telephone network (PSTN), digital subscriber line (DSL), digital cable, a direct cable connection, and/or another data connection/network, and/or via a wireless interface with, for example, a cellular network, a wireless local area network (WLAN)1 a digital television network such as a DVB-H network, a satellite network, an AM/FM broadcast transmitter, and/or another communication terminal. A communication terminal or an electronic device that is configured to communicate over a wireless interface may be referred to as a “wireless communication terminal,” a “wireless terminal” and/or a “mobile terminal.” Examples of mobile terminals and electronic devices include, but are not limited to, a satellite or cellular radiotelephone; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver.

In accordance with an aspect, in one embodiment of the present disclosure, a frame assembly for an electronic device is provided. The frame assembly includes a first frame and a second frame. The first frame defines a receiving space for accommodating electronic elements of the electronic device. The first frame includes an exterior surface departing from the receiving space. The second frame is coupled to the exterior surface of the first frame. The first frame is made of a glass material, and the second frame is made of a material different from the glass material of the first frame.

In accordance with an aspect, in another embodiment of the present disclosure, a housing is provided. The housing includes a rear cover and a frame assembly coupled to the rear cover. The frame assembly includes a first frame and a second frame. The first frame defines a receiving space for accommodating electronic elements of the electronic device. The first frame includes an exterior surface departing from the receiving space. The second frame is coupled to the exterior surface of the first frame. The first frame is made of a glass material, and the second frame and the first frame are made of different materials.

In accordance with an aspect, in further another embodiment of the present disclosure, an electronic device is provided. The electronic device includes a rear cover, a display module, and frame assembly. The rear cover and the display module are coupled to opposite sides of the frame assembly. The frame assembly includes a first frame and a second frame. The first frame defines a receiving space for accommodating electronic elements of the electronic device. The first frame includes an exterior surface departing from the receiving space. The second frame is coupled to the exterior surface of the first frame. The first frame is a glass-made frame, and the second frame is a non-glass-made frame.

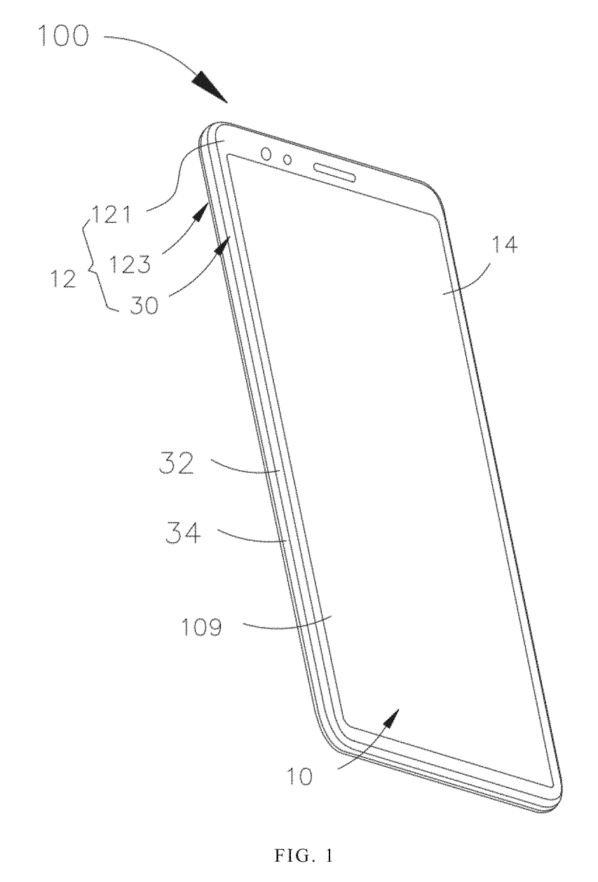

As illustrated in FIG. 1, an electronic device 100 is provided, in accordance with an embodiment of the present disclosure. The electronic device 100 can be any device with communication function and storage function, such as: a tablet, a mobile phone, an e-reader, a remote control, a personal computer (PC), a notebook computer, car device, a network television, a wearable device smart, or other smart device with network capabilities. The electronic device 100 of the illustrated embodiment will be described by taking a mobile phone as an example.

The electronic device 100 includes a housing 12 and an electronic component 10. The electronic component 10 includes a display module 14 and a plurality of electronic elements (not illustrated). The display module 14 is coupled to the housing 12. The electronic elements are received in the housing 12.

The housing 12 is configured to support the display module 14 and receive electronic elements of the electronic device 100. In the embodiment illustrated in FIG. 1, the housing 12 includes a front cover 121, a rear cover 123, and a frame assembly 30. The frame assembly 30 is disposed between and coupled to the front cover 121 and the rear cover 123. The display module 14 coupled to one side of the frame assembly 30, and the rear cover 123 is coupled to an opposite side of the frame assembly 30.

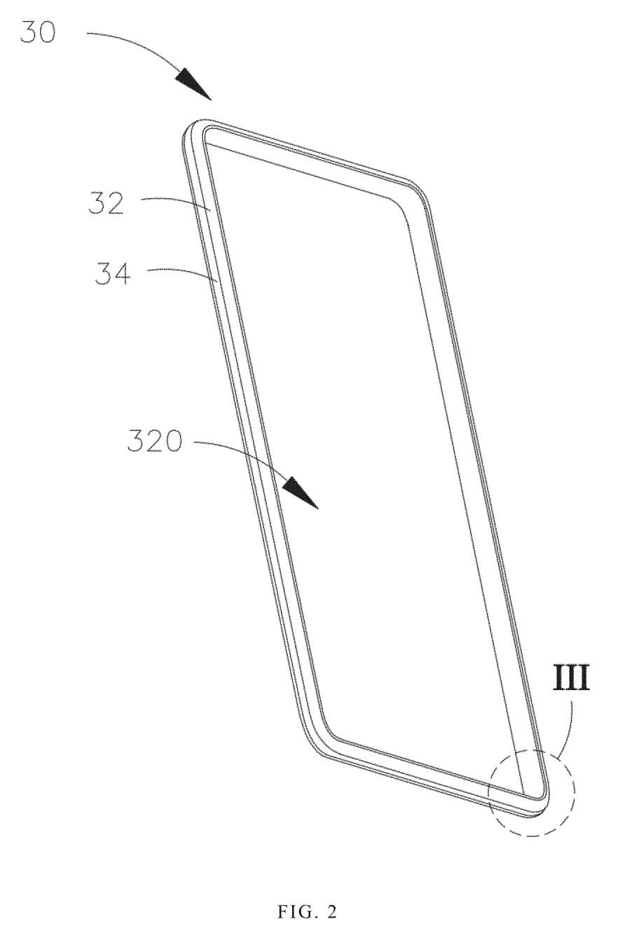

As illustrated in FIG. 1 and FIG. 2, in one embodiment, the frame assembly 30 may be a middle bezel assembly of the electronic device 100. The frame assembly 30 is substantially a rectangular frame and forms a frame of the electronic device 100. In some embodiment, the frame of the electronic device 100 may combine with the front surface by molding. In another embodiment, the frame may combine with the rear cover by molding. In still another embodiment, the frame may be an independent member and assembled to the rear cover 123 and the front cover 123. In the embodiment illustrated in FIG. 1, the frame assembly 30 is assembled with the rear cover 123 and the front cover 121.

As illustrated in FIG. 3, the frame assembly 30 includes a first frame 32 and a second frame 34. The first frame 32 defines a receiving space 320 for accommodating the electronic elements of the electronic device 100. The second frame 34 is coupled to the first frame 32. Furthermore, the second frame 34 is coupled to an exterior surface of the first frame 32 departing away from the receiving space 320. And the second frame 34 is extending around the first frame 32. The first frame 32 is made of a glass material, and the second frame 34 is made of a material different from the glass material of the first frame 32. In other words, the second frame 34 is a non-glass frame, and the first frame 32 and the second frame are made of different material. By this way, the non-glass-made second frame 34 is disposed on an exterior surface of the glass-made first frame 32 to protective the first frame 32. And the second frame 34 can serve as a decoration and a dumper for the frame assembly 30 and the electronic device 100. In some alternative embodiment, the second frame 34 may be a non-metal frame.

In some embodiments, the material of the second frame 34 is selected from a group of metal, plastic, resin, or rubber, and any combination thereof. In some alternative embodiments, the material of second frame 34 may be made of an elastic material, such as plastic, resin, and rubber, and any combination thereof. In one embodiment, a toughness of the second frame 34 is greater than a toughness of the first frame 32.

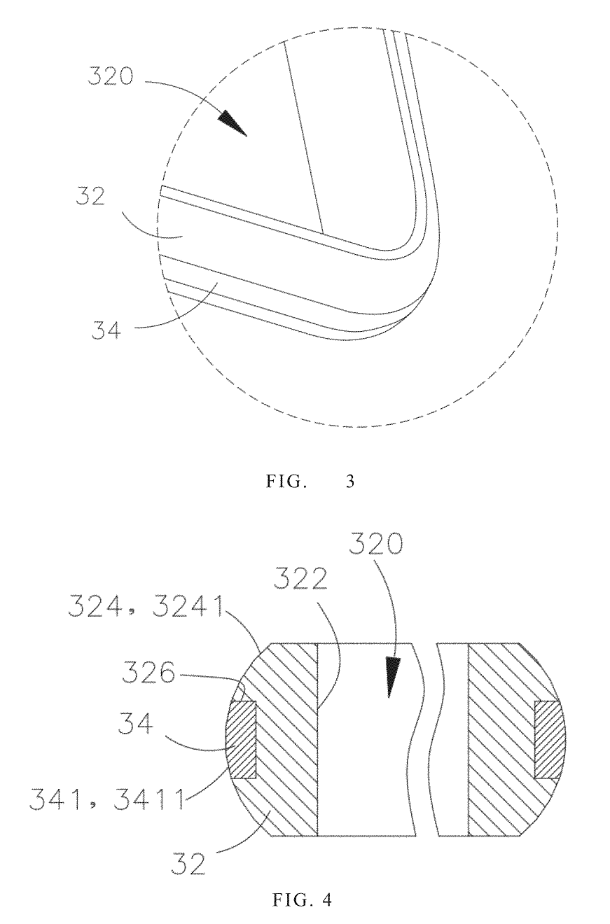

As illustrated in FIG. 4, in one embodiment, the first frame 32 includes an interior surface 322 and an exterior surface 324. The interior surface 322 and the exterior surface 32 are disposed at two opposite sides of the first frame 32, and the interior surface 322 faces the receiving space 320. The first frame 32 defines a mounting groove 326 in the exterior surface 324. The mounting groove 326 is configured to receive the second frame 34. The mounting groove 324 extends along a periphery direction of the first frame 32, and the second frame 34 is engaged into the mounting groove 324 and surrounds the first frame 32.

Furthermore, the mounting groove 326 is located substantially at an intermediate position on the exterior surface 324 along a height direction of the first frame 32. So that the second frame 34 can be disposed at a peak of the exterior surface 324 when the second frame 34 is received in the mounting groove 326. In one embodiment, an out surface of the frame assembly 30 is a curved surface, and the second frame 34 is located at a peak of the curved surface. That is, an out surface of the second frame 34 and the exterior surface 326 of the first frame 324 cooperatively form the out surface of the frame assembly 30. So that when the frame assembly 30 is dropped, an impact portion may firstly apply to the second frame 34. Therefore, a cushioning performance of the second frame 34 is effectively configured to protect the frame assembly 30 from damaged. It should be noted that the height direction of the first frame 32 described above should be considered as a direction that coincides with a thickness of the electronic device 100.

Furthermore, the second frame 34 includes an exposed surface 341 departing from the receiving space 320. The exposed surface 341 is smoothly connected with the exterior surface 324 of the first frame 32. In some embodiments, the exterior surface 324 is a curved surface, and the exposed surface 341 is also a curved surface that continuous with the exterior surface 324. In the embodiment illustrated in FIG. 4, in a cross-sectional view of the frame assembly 30 taken along the height direction thereof, a cross-sectional outer contour of the exterior surface 324 is presented as a first arc 3241, and a cross-sectional outer contour of the exposed surface 341 is presented as a second arc 3411 that continuous with the first arc 3241. The second arc 3411 is substantially smoothly coupled with the first arc 3241. So that the frame assembly 30 can have a smooth outer surface. In some alternative embodiments, the exposed surface 341 and the exterior surface 324 may be other structures except curved surfaces. For example, the exposed surface 341 and the exterior surface 324 may be planar surfaces or other curved surfaces (such as a concave curved surfaces, wave surfaces, etc.)

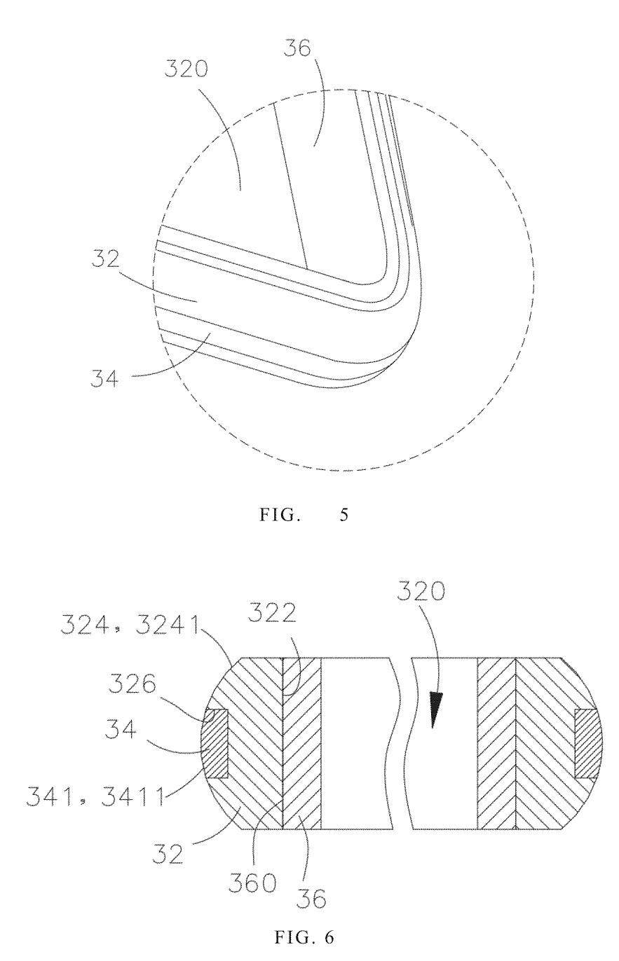

As illustrated in FIG. 5 and FIG. 6, in one embodiment, the frame assembly 30 further includes a third frame 36 coupled to the interior surface 322 of the first frame 32. The third frame 36 is made of a metal to support the first frame 32. So that the frame assembly 30 can have a relatively high strength and toughness. In some alternative embodiments, the material of the third frame 36 may be selected from the group of the iron, steel, stainless steel, copper, phosphor bronze, beryllium copper, nickel copper alloy, and magnesium aluminum alloy, etc., and any combination thereof.

Furthermore, in some embodiments, the first frame 32 may be a transparent glass frame. The third frame 36 further includes a decorative pattern 360 formed on a surface thereof facing the first frame 32. So that a user can observe the decorative pattern 360 through the first frame 32. The decorative pattern 360 of the third frame 36 can be directly formed on the third frame 36, and may be an etching pattern, a silk screen pattern, or a laser engraving pattern, or any combination of the above.

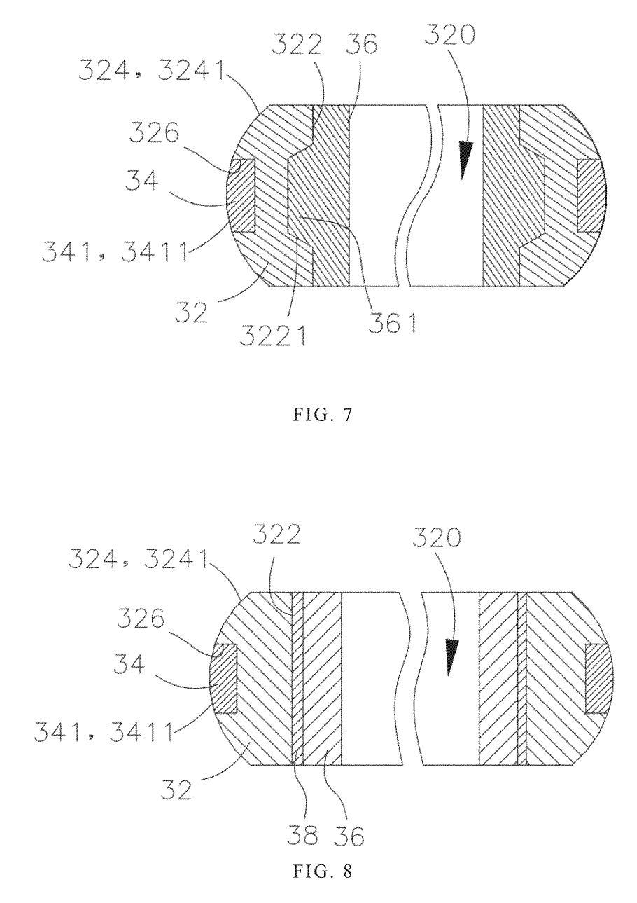

As illustrated in FIG. 7, in one embodiment, the first frame 32 further defines a first mounting portion 3221 in the interior surface 322 thereof, and the third frame 36 further includes a second mounting portion 361 engaged with the first mounting portion 3221. The second mounting portion 361 is embedded with the first mounting portion 3221. In the embodiment illustrated in FIG. 7, the first mounting portion 3221 is a depression defined in the interior surface, and the second mounting portion 361 is a protrusion. The protrusion is cooperated with and received in the depression. Furthermore, the first mounting portion 3221 may be a groove extending in a circumferential direction of the first frame 32. In other embodiments, the first mounting portion 3221 may be a plurality of grooves discretely distributed on the interior surface 322 of the first frame 32. In still other embodiments, the first mounting portion 3221 can be one or more protrusions, and the second mounting portion 361 can be one or more depressions.

In some embodiment, the third frame 36 may be a closed loop or a non-closed loop structure. When the third frame 36 is a closed loop, it may be an integrally formed closed annular frame, or may be a closed frame assembled together by a plurality of side frames. For example, the third frame 36 may include a plurality of side frames, and the plurality of side frames are sequentially end to end to form a closed loop frame. The connection between the plurality of side frames may be an integrally molding connection or an assembled connection. When the third frame 36 is a non-closed frame, it may define at least one opening. For example, the third frame 36 may include a plurality of side frames coupled to the interior surface 322, and at least two of the plurality of side frames are spaced apart from each other to form the opening such that the third frame 36 is a non-closed frame. The opening may be an un-shielded slot that is filled with un-shielded material.

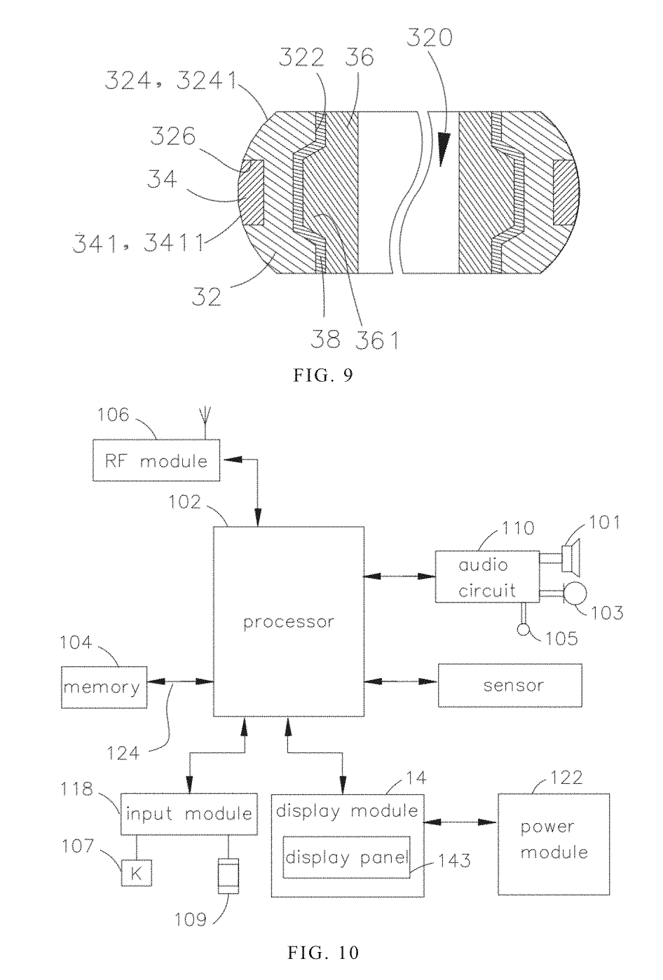

As illustrated in FIG. 8 and FIG. 9, in some embodiments, the frame assembly 30 further includes an interlayer 38. The interlayer 38 is sandwiched between the first frame 32 and the third frame 36. In the illustrated embodiments, the interlayer 38 is an adhesive layer for bonding the third frame 36 and the first frame 32. For example, the interlayer 38 may be made of a bonding material such as glue or double-sided tape. In other embodiments, the interlayer 38 may be a decorative layer. For example, the interlayer 38 may be a decorative sheet disposed between the first frame 32 and the third frame 36, such as a film sheet or other decorative material. In still other alternative embodiments, the interlayer 38 can be a buffer layer for achieving and buffering between the first frame 32 and the third frame 36. And the interlayer 38 can be configured to absorb impact energy of the frame assembly 30 when dropped. Furthermore, the interlayer 38 may be made of elastic material. For example, the material of the interlayer 38 can be selected from a group of plastic, resin, and rubber, and any combination thereof.

Furthermore, in some embodiments, the frame assembly 30 may define one or more through holes (not illustrated) therein. The through holes may be configured to accommodate one or more physical buttons of the electronic device 100. The through hole can also be configured as a power entry, a data entry, a headphone hole, a speaker sound hole, a microphone sound entry, and the like of the electronic device 100. The through hole may penetrate one or more of the first frame 32, the second frame 34, the third frame 36, and the interlayer 38.

In the electronic device 100 provided in the present disclosure, by providing the non-glass-made second frame 34 coupled to the glass-made first frame 32, the second frame 34 can serve as a bumper of the frame assembly 30, and the first frame 32 is protective by the second frame 34. In addition, because the second frame 34 and the first frame 32 are made from different material, the non-lass-made second frame 34 can act as a decorative role.

As illustrated in FIG. 10, in the actual disclosure scenario, the electronic device 100 can be used as a smart electronic device, such as a smart phone terminal, in which case the electronic component 10 is usually further includes one or more (only one is illustrated) processors 102, a memory 104, a Radio Frequency (RF) module 106, an audio circuit 110, a sensor, an input module 118, and a power module 122. It will be understood by those skilled in the art that the structure illustrated in FIG. 10 is merely illustrative and does not limit the structure of the electronic component 10. For example, the electronic component 10 may include more or less components those illustrated in FIG. 10, or have a different configuration that illustrated in FIG.

One of ordinary skill in the art will appreciate that all other components are peripherals relative to the processor 102. The processor 102 is coupled to the peripherals via a plurality of peripheral interfaces 124. The peripheral interface 124 can be implemented based on the following standards: Universal Asynchronous Receiver/Transmitter (UART), General Purpose Input Output (GPIO), Serial Peripheral Interface (SPI), Inter-Integrated Circuit (I2C), but not limited to the above standards. In some examples, peripheral interface 124 may only include a bus; in other examples, peripheral interface 124 may also include other components, such as one or more controllers, such as a display controller for connecting display panel 143 or a memory controller configured to connect to the memory. In addition, these controllers can also be detached from the peripheral interface 124 and integrated into the processor 102 or within a corresponding peripheral.

The memory 104 can be configured to store software programs and modules. The processor 102 executes various functional disclosures and data processing by executing software programs and modules stored in the memory 104. The memory 104 may include high speed random access memory and may also include non-volatile memory such as one or more magnetic storage devices, flash memory, or other non-volatile solid state memory. In some embodiments, the memory 104 may further include a memory remotely located relative to processor 102, which may be coupled to the electronic component 10 or display module 14 via a network. Examples of such networks may include, but are not limited to, the Internet, intranets, local area networks, mobile communication networks, and combinations thereof.

The RF module 106 is configured to receive and transmit electromagnetic waves, and convert electromagnetic waves and electrical signals to communicate with a communication network or other device. The RF module 106 can include various existing circuit components for performing the communication functions, such as an antenna, a radio frequency transceiver, a digital signal processor, an encryption/decryption chip, a Subscriber Identity Module (SIM) card, a memory, and the like. The RF module 106 can communicate with various networks such as the Internet, an intranet, a wireless network, or communicate with other devices via a wireless network. The wireless network described above may include a cellular telephone network, a wireless local area network, or a metropolitan area network. The above wireless network can use various communication standards, protocols and technologies, including but not limited to Global System for Mobile Communication (GSM), Enhanced Data GSM Environment (EDGE), and wideband code. Wideband code division multiple access (W-CDMA), Code division access (CDMA), time division multiple access (TDMA), wireless fidelity (Wireless, Fidelity), Wi-Fi) (such as the Institute of Electrical and Electronics Engineers Standards IEEE 802.10A, IEEE 802.11b, IEEE 802.11g and/or IEEE 802.11n), Voice over internet protocol (VoIP), Worldwide Interoperability (Worldwide Interoperability) For Microwave Access, Wi-Max, other protocols for mail, instant messaging and short messages, and any other suitable communication protocols, even those that are not currently being developed.

The audio circuit 110, the speaker 101, the sound jack 103, and the microphone 105 cooperatively provide an audio interface between a user and the electronic component 10 or the display module 14. In the illustrated embodiment, the audio circuit 110 can receive a sound data from the processor 102, and the audio circuit 110 can convert the sound data into an electrical signal, and transmit the electrical signal to the speaker 101. The speaker 101 can convert the electrical signal into a sound wave that can be heard by a human ear. The audio circuit 110 can also receive electrical signals from the microphone 105, and convert the electrical signals into sound data, and further transmit the sound data to the processor 102 for further processing. The audio data may be obtained from memory 104 or the RF module 106. Additionally, audio data may also be stored in memory 104 or transmitted by the RF module 106.

Sensors are disposed in the electronic component 10 or in the display module 14. Examples of the sensors can include, but are not limited to, light sensors, operational sensors, pressure sensors, gravity acceleration sensors, and other sensors.

In this embodiment, the input module 118 can include a 109 disposed on the display module 14. The touch screen 109 can collect touch operations on or near the touch screen 109 (such as a user using a finger, a stylus, etc., or any suitable object or accessory operates on or adjacent to the touch screen 109), and drive a corresponding connection device according to a predetermined program.

Alternatively, touch screen 109 may include a touch detector and a touch controller. Wherein, the touch detector can detect the touch orientation of the user, and detect a signal brought by the touch operation, and transmits a touch signal to the touch controller. The touch controller can receive the touch signal from the touch detector, and convert the touch signal into touch coordinates, and then transmit the touch coordinates to the processor 102, and can receive a command generated by the processor 102 and execute it. In addition, the touch detection function of the touch screen 109 can be implemented by various types such as resistive, capacitive, infrared, and surface acoustic waves. In addition to touching display 109, in other variant embodiments, input module 118 may also include other input devices, such as button 107. The button 107 may include, for example, a character button for inputting a character, and a control button for triggering a control function. Examples of control buttons include a “return to home screen” button, a power on/off button, and the like.

The display module 14 is configured to display information input by the user, information provided to the user, and various graphical user interfaces of the electronic component 10, which can be composed of graphics, text, icons, numbers, videos, and any combination thereof. In one example, the touch screen 109 can be disposed on the display panel 143 to be integrated with the display panel 143.

The power module 122 is configured to provide power to the processor 102 and other components. In the illustrated embodiment, the power module 122 may include a power management system, one or more power sources (such as a battery or an alternating current), a charging circuit, a power failure detecting circuit, an inverter, a power status indicator, and any other with the electronic component 10 or a components related to the generation, management, and distribution of power within the display module 14.

The electronic device 100 can also include a locator 119 for determining the actual location at which the electronic device 100 is located. In this embodiment, the locator 119 applies a location service to implement the positioning of the electronic device 100. The positioning service should be understood as a technology or service of the location of the object being located, which acquire the location information (such as latitude and longitude coordinates) of the electronic device 100 by using a specific positioning technology, and marking the electronic map.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A frame assembly for an electronic device, comprising:
a first frame defining a receiving space for accommodating electronic elements of the electronic device, the first frame comprising an exterior surface departing from the receiving space; and
a second frame coupled to the exterior surface of the first frame; wherein the first frame is made of a glass material, and the second frame is made of a material different from the glass material of the first frame.

2. The frame assembly as claimed in claim 1, wherein a toughness of the second frame is greater than a toughness of the first frame.

3. The frame assembly as claimed in claim 1, wherein the material of the second frame is selected from a group of metal, plastic, resin, rubber, and any combination thereof.

4. The frame assembly as claimed in claim 1, wherein the first frame defines a mounting groove in the exterior surface, and the second frame is engaged into the mounting groove.

5. The frame assembly as claimed in claim 4, wherein the mounting groove extends in a periphery direction of the first frame, and the second frame surrounds the first frame.

6. The frame assembly as claimed in claim 4, wherein the second frame comprises an exposed surface departing from the receiving space; the exposed surface is smoothly connected with the exterior surface.

7. The frame assembly as claimed in claim 6, wherein the exterior surface is a curved surface, and the exposed surface is a curved surface; the exposed surface is continuous with the exterior surface.

8. The frame assembly as claimed in claim 4, wherein the first frame further comprises an interior surface facing the receiving space, the frame assembly further comprises a third frame, and the third frame is coupled to the interior surface of the first frame.

9. The frame assembly as claimed in claim 8, wherein the third frame is made of a material selected from a group of iron, steel, stainless steel, copper, phosphor bronze, copper, beryllium copper, nickel copper alloy, magnesium alloy, and any combination thereof.

10. The frame assembly as claimed in claim 8, wherein the first frame is transparent, and the third frame has a surface facing the first frame, and a decorative pattern is formed on the surface.

11. The frame assembly as claimed in claim 10, wherein the decorative pattern is an etching pattern, a silk screen pattern, or a laser engraving pattern, or any combination thereof.

12. The frame assembly as claimed in claim 8, wherein the first frame further defines a first mounting portion in the interior surface, and the third frame further comprises a second mounting portion; the second mounting portion is engaged with the first mounting portion.

13. The frame assembly as claimed in claim 12, wherein the first mounting portion is a depression defined in the interior surface, the second mounting portion is a protrusion cooperated with and received in the depression.

14. The frame assembly as claimed in claim 8, wherein the third frame is a closed loop frame or a non-closed loop frame.

15. The frame assembly as claimed in claim 8, wherein the frame assembly further comprises an interlayer; the interlayer is sandwiched between the third frame and the first frame.

16. The frame assembly as claimed in claim 15, wherein the interlayer is an adhesive layer, a decorative layer, or a buffer layer, or any combination thereof.

17. A housing for an electronic device, comprising:
a rear cover, and
a frame assembly coupled to the rear cover; the frame assembly having:
a first frame defining a receiving space for accommodating electronic elements of the electronic device, the first frame comprising an exterior surface departing from the receiving space; and
a second frame coupled to the exterior surface of the first frame; wherein the second frame and the first frame are made of different materials.

18. The housing as claimed in claim 17, wherein the first frame further comprises an interior surface facing the receiving space, and the frame assembly further comprises a third frame; the third frame is coupled to the interior surface.

19. The housing as claimed in claim 17, wherein the first frame defines a mounting groove in the exterior surface, and the second frame is engaged into the mounting groove.

20. An electronic device, comprising:
a rear cover;
a display module; and
a frame assembly, the rear cover and the display module being coupled to opposite sides of the frame assembly; and the frame assembly having:
a first frame defining a receiving space for accommodating electronic elements of the electronic device, the first frame comprising an exterior surface departing from the receiving space; and
a second frame coupled to the exterior surface of the first frame; wherein the first frame is a glass-made frame, and the second frame is a nonmetal frame.
